(19) United States
(12) Patent Application Publication
(10) Pub. No.: US 2016/0083290 A1
(43) Pub. Date: Mar. 24, 2016

(54) GLASS FOR IR-CUT FILTER

(71) Applicant: NIPPON ELECTRIC GLASS CO., LTD., Shiga (JP)

(72) Inventor: Satoko KONOSHITA, Otsu-shi (JP)

(73) Assignee: NIPPON ELECTRIC GLASS CO., LTD., Otsu-shi, Shiga (JP)

(21) Appl. No.: 14/784,643

(22) PCT Filed: Jun. 16, 2014
(86) PCT No.: PCT/JP2014/065850

§ 371 Date: Oct. 15, 2015

(30) Foreign Application Priority Data
Jul. 5, 2013 (JP) 2013-141355

(51) Int. Cl. C03C 4/08; G02B 5/20; G02B 5/22; C03C 3/17

(52) U.S. Cl. CPC C03C 4/082; C03C 3/17; G02B 5/208; G02B 5/226

(57) ABSTRACT

Provided is a glass for an IR-cut filter that has high weather resistance even without fluorine component, a high glass transition point, and excellent polishing workability. The glass for an IR-cut filter contains, in % by mole, 1% or more SO₃, 10 to 50% P₂O₅, 1 to 15% CuO, 0.1 to 10% Al₂O₂, 5 to 50% RO (where R is at least one selected from among Zn, Ca, Sr, and Ba), and 0 to 30% R′₂O (where R′ is at least one selected from among Na, Li, and K) and is substantially free of fluorine component.

### TECHNICAL FIELD

This invention relates to a glass for an IR (infrared) cut filter suitable as a color correction filter for a digital still camera, a color video camera, and so on.

### BACKGROUND ART

Solid-state image pickup devices, such as COMS (complementary metal-oxide semiconductors), for use in digital still cameras, color video cameras, and so on, have recently increased their sensitivity in a wide range from visible to near-infrared region. The solid-state image pickup devices correct, in the near-infrared region, their spectral sensitivity using an IR-cut filter. Phosphate glass is mainly used in the IR-cut filter.

Conventionally, fluorophosphate glass is proposed which contains a fluorine component in order to increase the weather resistance of phosphate glass for use in an IR-cut filter. The glass is generally produced by forming molten glass into a sheet, cutting the sheet into a desired size, polishing it, and processing it into a final shape (see, for example, Patent Literatures 1 to 4).

### CITATION LIST

### Patent Literature

### [PTL 1]

JP-A-2012-208527

### [PTL2]

JP-A-2010-59013

### [PTL3]

JP-A-2010-52987

### [PTL4]

JP-A-2010-197595

### SUMMARY OF INVENTION

### Technical Problem

Phosphate glass used in conventional IR-cut filters has problems of low glass transition point and poor polishing workability caused by it. In addition, the fluorine component is a substances of environmental concern, which presents a problem in that its use is recently being restricted.

In view of the above, an object of the present invention is to provide a glass for an IR-cut filter that has high weather resistance even without fluorine component, a high glass transition point, and excellent polishing workability.

### Solution to Problem

The inventor has found from intensive studies that the above problems can be eliminated by optimizing the contents of components in phosphate glass containing sulfuric acid.

Specifically, a glass for an IR-cut filter of the present invention contains, in % by mole, 1% or more SO₃, 10 to 50% P₂O₅, 1 to 15% CuO, 0.1 to 10% Al₂O₃, 5 to 50% RO (where R is at least one selected from among Zn, Ca, Sr, and Ba), and 0 to 30% R′₂O (where R′ is at least one selected from among Na, Li, and K) and are substantially free of fluorine component.

The glass for an IR-cut filter of the present invention preferably further contains, in % by mole, 0 to 5% B₂O₃.

The glass for an IR-cut filter of the present invention is preferably substantially free of Cl component and Ag₂O.

Note that “substantially free of” herein means that the glass does not positively contain the relevant component as a raw material, and is not intended to exclude unavoidable incorporation of impurities. More specifically, this means that the content thereof is below 0.1%.

The glass for an IR-cut filter of the present invention preferably has a glass transition point of 300° C. or more.

The glass for an IR-cut filter of the present invention preferably has, as measured at a thickness where a wavelength (λ₅₀) exhibiting a transmittance of 50% in a wavelength range of 500 to 1200 nm is 615 nm, a transmittance of 80% or more at a wavelength of 500 nm and a transmittance of 25% or less at a wavelength of 1100 nm.

An IR-cut filter of the present invention is made of any one of the above-described glasses.

### Advantageous Effects of Invention

The present invention makes it possible to provide a glass for an IR-cut filter that has high weather resistance even without fluorine component, a high glass transition point, and excellent polishing workability.

### BRIEF DESCRIPTION OF DRAWINGS

FIG. 1 is a graph showing a transmittance curve of sample No. 2 as an example.

### DESCRIPTION OF EMBODIMENTS

A glass for an IR-cut filter of the present invention contains, in % by mole, 1% or more SO₃, 10 to 50% P₂O₅, 1 to 15% CuO, 0.1 to 10% Al₂O₃, 5 to 50% RO (where R is at least one selected from among Zn, Ca, Sr, and Ba), and 0 to 30% R′₂O (where R′ is at least one selected from among Na, Li, and K) and are substantially free of fluorine component. The reasons why the glass composition is defined as described above will be described below.

SO₃ is a component for improving the weather resistance. Furthermore, SO₃ is likely to oxidize the Cu component to Cu²⁺ and Cu ions are, in the presence of SO₃, likely to have a six-coordinate geometry (that is, the oxygen coordination number of Cu ions is likely to increase), resulting in the likelihood of a low transmittance in the near-infrared region. The SO₃ content is 1% or more, preferably 3% or more, and more preferably 5% or more. If the SO₃ content is too small, the above effect is difficult to achieve. The upper limit on the SO₃ content is not particularly placed. However, if the SO₃ content is too large, the glass transition point is likely to decrease. In addition, vitrification tends to be difficult. Therefore, the SO₃ content is preferably not more than 40%, more preferably not more than 30%, and still more preferably not more than 20%.

P₂O₅ is an essential component for forming the glass network. The P₂O₅ content is 10 to 50%, preferably 15 to 45%, and more preferably 18 to 40%. If the P₂O₅ content is too small, this makes vitrification less likely. On the other hand, if the P₂O₅ content is too large, the weather resistance is likely to deteriorate.

CuO is an essential component for absorbing infrared. Furthermore, CuO has the effect of raising the glass transition point. In addition, in the coexistence with SO₃, CuO has the effect of strengthening the phosphate network of the glass and improving the weather resistance. The CuO content is 1 to 15% and preferably 2 to 10%. If the CuO content is too small, the above effects are difficult to achieve. On the other hand, if the CuO content is too large, this makes vitrification less likely.

Cu element in CuO exists as ions in glass and absorbs light in a particular wavelength range. Because the range of wavelengths absorbable by an ion differs depending upon the valence and coordination state of the ion, the valence and coordination state of the ion in glass need to be controlled in order to give a desired light absorption effect. Generally, Cu ions have a higher absorption intensity in the infrared or ultraviolet region with increasing oxidation number. For this reason, an oxidizing agent, such as antimony (Sb), is generally added to the glass. In contrast, the glass for an IR-cut filter of the present invention has high oxidation performance and therefore has a feature in that it can provide a good light absorption characteristic without addition of any oxidizing agent.

Al₂O₃ is an effective component to improve the weather resistance. The Al₂O₃ content is 0.1 to 10%, preferably 0.1 to 7%, more preferably 0.1 to 5%, and still more preferably 0.5 to 3%. If the Al₂O₃ content is too small, the above effect is difficult to achieve. If the Al₂O₃ content is too large, this makes vitrification less likely. In addition, oxygen around the Cu ions is reduced, so that the near-infrared absorption characteristic of the Cu ions is likely to deteriorate.

RO (where R is at least one selected from among Zn, Ca, Sr, and Ba) is an effective component to stabilize vitrification. In addition, RO is a component for improving the weather resistance. The RO content is, in total, preferably 5 to 50%, more preferably 10 to 40%, and still more preferably 15 to 35%. If the RO content is too small, the above effects are difficult to achieve. On the other hand, if the RO content is too large, this makes vitrification less likely.

Among RO components, ZnO can easily give the above effects. The ZnO content is preferably 5 to 50%, more preferably 10 to 45%, and still more preferably 25 to 45%. Each of the CaO content and SrO content is preferably 0 to 40% and more preferably 0.1 to 30%. The BaO content is 0 to 9%, more preferably 0 to 5%, and still more preferably 0 to 1%. Particularly preferably, the glass contains no BaO.

R′₂O (where R′ is at least one selected from among Na, Li, and K) is a component for stabilizing vitrification and improving the mass productivity. Furthermore, R′₂O cuts the chain-like P₂O₅ network and increases the oxygen coordination number of Cu ions, resulting in the likelihood of a reduced transmittance in the near-infrared region. The R′₂O content is preferably 0 to 30%, more preferably 1 to 25%, still more preferably 5 to 20%, and particularly preferably 10 to 19%. If the R′₂O content is too large, the weather resistance tends to deteriorate and the glass transition point tends to be too low. In addition, vitrification becomes difficult.

Among R′₂O components, Na₂O can easily give the above effects. The Na₂O content is preferably 0 to 30%, more preferably 1 to 25%, still more preferably 5 to 20%, and particularly preferably 10 to 18%. The Li₂O content is preferably 0 to 20% and more preferably 0.1 to 18%. The K₂O content is preferably 0 to 15% and more preferably 0.1 to 10%. The coexistence of two or more R′₂O components (for example, Li₂O and Na₂O) facilitates improvement of the weather resistance.

The fluorine component is effective to improve the weather resistance, but is a substances of environmental concern. Therefore, the glass of the present invention is substantially free of fluorine component.

The glass for an IR-cut filter of the present invention may contain, in addition to the above components, the following components.

B₂O₃ is a component having the effect of stabilizing the glass. However, if its content is too large, the volatile content increases during melting to easily cause composition deviation. In addition, the weather resistance is likely to deteriorate. Therefore, the B₂O₃ content is preferably 0 to 5% and more preferably 0 to 3%. Still more preferably, the glass is substantially free of B₂O₃.

SiO₂ has the effect of raising the glass transition point, but tends to make vitrification unstable. Therefore, the SiO₂ content is preferably 0 to 4% and more preferably 0 to 2%. Still more preferably, the glass is substantially free of SiO₂.

The glass is preferably substantially free of Cl component in consideration of effects on the human body. The glass is preferably substantially free of Ag₂O because it can have an effect on the valence of CuO.

If the raw material for the glass contains a large amount of U component or Th component as impurities, the resultant glass emits α-rays. Therefore, if the glass is applied to a spectral sensitivity correction filter or a color tuning filter, α-rays may cause problems with signals of a CCD or CMOS. Hence, the content of each of the U and Th components in the glass for an IR-cut filter of the present invention is preferably not more than 1 ppm, more preferably not more than 100 ppb, and still more preferably not more than 20 ppb. Furthermore, the dose of α-rays emitted from the glass for an IR-cut filter of the present invention is preferably 1.0 c/cm²·h or less.

The glass for an IR-cut filter of the present invention can sharply cut off near-infrared light while maintaining a high transmittance in the visible range. Specifically, the glass preferably has, as measured at a thickness where a wavelength (λ₅₀) exhibiting a transmittance of 50% in a wavelength range of 500 to 1200 nm is 615 nm, a transmittance of 80% or more (more preferably 82% or more) at a wavelength of 500 nm and a transmittance of 25% or less (more preferably 15% or less) at a wavelength of 1100 nm.

Next, a description will be given of a method for producing an IR-cut filter using the glass of the present invention.

First, glass raw materials are mixed together to give a desired composition and then melted in a glass melting furnace. Next, the molten glass is rapidly solidified to form it into a shape, then, if necessary, cut it into a desired shape (for example, a flat sheet shape), and polish it to obtain an IR-cut filter.

### Examples

Hereinafter, the glass for an IR-cut filter of the present invention will be described in detail with reference to examples, but is not limited to the examples.

(1) Preparation of Each Sample

Table 1 shows examples of the present invention (samples Nos. 1 to 7) and Table 2 shows comparative examples (samples Nos. 8 to 12).

TABLE 1

| % by mole | 1 | 2 | 3 | 4 | 5 | 6 | 7 |
|---|---|---|---|---|---|---|---|
| SO₃ | 13 | 8 | 8 | 18 | 3 | 15 | 10 |
| P₂O₅ | 24 | 25 | 35 | 20 | 45 | 17 | 25 |
| CuO | 5 | 5 | 7 | 3 | 3 | 9 | 5 |
| Al₂O₃ | 1 | 1 | 2 | 1 | 5 | 1 | 2 |
| ZnO | 36 | 40 | 32 | 40 | 20 | 43 | 46 |
| CaO | 1 | 1 | 1 | | | | 1 |
| SrO | 1 | 1 | | | | | 1 |
| BaO | | | | | | | |
| Li₂O | 5 | 5 | 4 | | 6 | | |
| Na₂O | 8 | 8 | 7 | 18 | 12 | 15 | 10 |
| K₂O | 6 | 6 | 4 | | 6 | | |
| Glass Transition | 315 | 315 | 305 | 310 | 350 | 360 | 380 |
| Point (° C.) | | | | | | | |
| Thickness (mm) | 0.3 | 0.3 | 0.2 | 0.5 | 0.5 | 0.15 | 0.3 |
| Transmittance | 88 | 89 | 88 | 89 | 88 | 88 | 88 |
| 500 nm (%) | | | | | | | |
| Transmittance | 10 | 10 | 10 | 10 | 10 | 10 | 10 |
| 1100 nm (%) | | | | | | | |
| Weather Resistance | ◯ | ◯ | ◯ | ◯ | ◯ | ◯ | ◯ |

TABLE 2

| % by mole | 8 | 9 | 10 | 11 | 12 |
|---|---|---|---|---|---|
| SO₃ | 18 | | 9 | 22 | 16 |
| P₂O₅ | 20 | 45 | 15 | 22 | 22 |
| CuO | 4 | 5 | 1 | 6 | |
| Al₂O₃ | | 1 | 1 | 2 | 1 |
| ZnO | 38 | 30 | 40 | 3 | 40 |
| CaO | | | | 3 | 1 |
| SrO | | 1 | 4 | 3 | 1 |
| BaO | | | 15 | | |
| Li₂O | 1 | 5 | 5 | 7 | 5 |
| Na₂O | 18 | 8 | 5 | 25 | 8 |
| K₂O | 1 | 5 | 5 | 7 | 6 |
| Glass Transition Point (° C.) | — | — | Not | Not | 280 |
| Thickness (mm) | — | — | Vitrified | Vitrified | 0.3 |
| Transmittance 500 nm (%) | — | — | | | 90 |
| Transmittance 1100 nm (%) | — | — | | | 90 |
| Weather Resistance | x | x | | | ∘ |

Each sample was prepared in the following manner.

First, each set of glass raw materials mixed to give a corresponding composition shown in the above tables were loaded into a platinum crucible and melted at 700 to 900° C. to give a homogeneous melt. Next, the molten glass was allowed to flow on a carbon plate, cooled to become solidified, and then annealed to prepare a glass sample.

(2) Evaluation of Each Sample

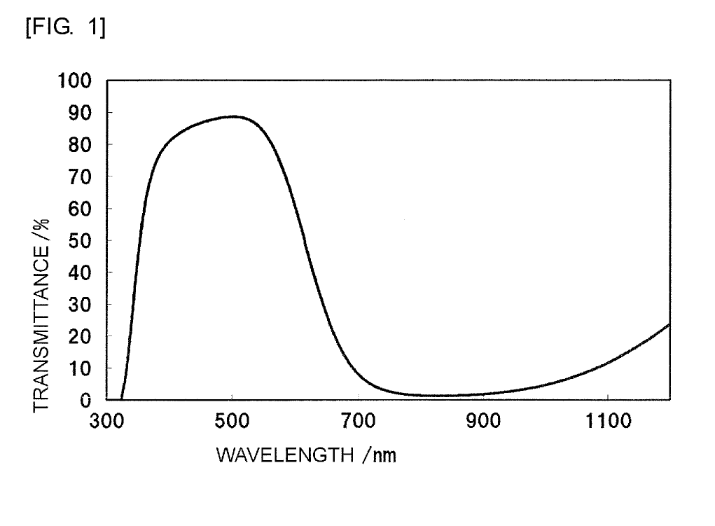

The obtained samples were measured or evaluated for glass transition point, spectral characteristics, and weather resistance by the following methods. The results are shown in Tables 1 and 2. Furthermore, the transmittance curve of sample No. 2 is shown in FIG. 1.

The glass transition point was determined, using a thermal expansion coefficient curve obtained with a dilatometer, from an intersection point between the line in a low-temperature range and the line in a high-temperature range.

The spectral characteristics were measured, using a sample mirror-polished on both sides by diamond powder having a particle size of 0.5 μm, with UV3100PC manufactured by Shimadzu Corporation. Each sample used was a sample having a thickness where a wavelength (λ₅₀) exhibiting a transmittance of 50% in a wavelength range of 500 to 1200 nm is 615 nm.

The weather resistance was evaluated in the following manner. The sample used to measure the spectral characteristics was allowed to stand in an environment at a temperature of 60° C. and a humidity of 90% for 500 hours and then measured in terms of transmittance at a wavelength of 500 nm. When the decrease of transmittance from before to after the test was less than 10%, the sample was evaluated to be good (“∘”). When the decrease of the transmittance after the test was 10% or more, the sample was evaluated to be no good (“x”).

(3) Consideration of Results

Samples Nos. 1 to 7, which are inventive examples, were homogeneous, had desired spectral characteristics, and also had excellent weather resistance. In contrast, samples Nos. 8 and 9, which are comparative examples, had poor weather resistance. Samples Nos. 10 and 11 could not be vitrified. Sample No. 12 had a glass transition point as low as 280 degrees C. In addition, sample No. 12 had a transmittance as high as 90% at a wavelength of 1100 nm.

1: A glass for an IR-cut filter containing, in % by mole, 1% or more SO₃, 10 to 50% P₂O₅, 1 to 15% CuO, 0.1 to 10% Al₂O₃, 5 to 50% RO (where R is at least one selected from among Zn, Ca, Sr, and Ba), and 0 to 30% R′₂O (where R′ is at least one selected from among Na, Li, and K) and being substantially free of fluorine component.

2: The glass for an IR-cut filter according to claim 1, the glass further containing, in % by mole, 0 to 5% B₂O₃.

3: The glass for an IR-cut filter according to claim 1, the glass being substantially free of Cl component and Ag₂O.

4: The glass for an IR-cut filter according to claim 1, the glass having a glass transition point of 300° C. or more.

5: The glass for an IR-cut filter according to claim 1, the glass having, as measured at a thickness where a wavelength (λ₅₀) exhibiting a transmittance of 50% in a wavelength range of 500 to 1200 nm is 615 nm, a transmittance of 80% or more at a wavelength of 500 nm and a transmittance of 25% or less at a wavelength of 1100 nm.

6: An IR-cut filter made of the glass according to claim 1.
